(19) United States
(12) Patent Application Publication
(10) Pub. No.: US 2022/0137837 A1
(43) Pub. Date: May 5, 2022

(54) STORAGE SYSTEM AND FILE RELOCATION METHOD FOR STORAGE SYSTEM

(71) Applicant: Hitachi, Ltd., Tokyo (JP)

(72) Inventors: Arata HAYASHI, Tokyo (JP); Yuta NISHIHARA, Tokyo (JP); Koki OMURA, Tokyo (JP)

(73) Assignee: Hitachi, Ltd., Tokyo (JP)

(21) Appl. No.: 17/463,275

(22) Filed: Aug. 31, 2021

(30) Foreign Application Priority Data
Oct. 29, 2020 (JP) 2020-181820

(51) Int. Cl. G06F 3/06; G06F 21/56

(52) U.S. Cl. CPC G06F 3/0619; G06F 3/0647; G06F 21/568; G06F 3/067; G06F 21/566; G06F 3/0659

(57) ABSTRACT

A controller of a storage apparatus 200 of a storage system manages a storage device as a volume A 220 in which files are stored and volumes B to D 221 to 223 in which backup files of the files are stored. The volumes B to D 221 to 223 are configured by a plurality of physical storage devices with different performances. The controller classifies the volumes B to D 221 to 223 into a plurality of storage tiers Tier1 to Tier3 for management in accordance with the performances of the physical storage devices. The controller performs relocation of the storage tiers Tier1 to Tier3 in which the backup files are stored in consideration of a logical fault occurrence time point of the host at which detection of a defect of an application and/or a system of the host is used as a trigger.

### CROSS-REFERENCE TO PRIOR APPLICATION

This application relates to and claim the benefit of priority from Japanese Patent Application No.2020-181820 filed on Oct. 29, 2020 the entire disclosure of which is incorporated herein by reference.

### BACKGROUND

The present invention relates to a storage system and a file relocation method for the storage system.

In the field of security, the idea of “Cyber Resilience” in which onset/discovery of malware is detected and handled has become mainstream, and thus a method or the like of realizing restoration from long-term latency of malware by combining multi-generational backup data and security software has been examined.

In cyber resilience, restoration from multi-generational backup data is realized as follows:
(1) after a security incident occurs, an infection time point of malware is estimated by security software or the like; and
(2) whether malware infection occurs is checked with the security software or the like with reference to backup data of an estimated infection time point. When infection occurs, it is checked again whether malware infection occurs with reference to backup data of an old generation. When no infection occurs, the backup data of this generation is restored.

Therefore, a storage is required to have a capacity for storing multi-generational backup data and access performance to the multi-generational backup data.

As technologies for implementing both the data capacity and the performance, tiering technologies are known (for example, U.S. Pat. No. 8,880,830 (Specification) and U.S. Pat. No. 8,918,609 (Specification)). In the technology disclosed in U.S. Pat. No. 8,880,830 (Specification), data migration is performed between tiered drives of a storage based on an access frequency of data.

However, in the tiering technologies disclosed in U.S. Pat. No. 8,880,830 (Specification) and U.S. Pat. No. 8,918,609 (Specification), since tiers of data are relocated in accordance with the access frequency, there is no access to backup data and restored data cannot be relocated to an upper tier at a timing at which restoration is necessary due to occurrence of a security incident. Therefore, when restoration speed is necessary, many expensive high-performance drives are necessary. To lower costs of the drives, it is necessary to use drives with low performance at the sacrifice of restoration speed.

The present invention has been devised in view of the foregoing circumstances and an objective of the present invention is to provide a storage system and a file relocation method for the storage system capable of finding a balance between cost and restoration speed of a storage device storing backup data.

### SUMMARY

To solve the foregoing problem, according to an aspect of the present invention, a storage system is connected to a host and performs an operation on stored files based on a file operation request from the host. The storage system includes a controller and a storage device. The controller manages the storage device as a first volume in which the files are stored and a second volume in which backup files of the files are stored. The second volume is configured by a plurality of physical storage devices with different performances and the controller classifies the second volume into a plurality of storage tiers for management in accordance with the performances of the physical storage devices. The controller performs relocation of the storage tiers in which the backup files are stored in consideration of a logical fault occurrence time point of the host at which detection of a defect of an application and/or a system of the host is used as a trigger.

According to the present invention, it is possible to realize a storage system and a file relocation method for the storage system capable of finding a balance between cost and restoration speed of a storage device storing backup data.

### BRIEF DESCRIPTION OF THE DRAWINGS

FIG. 1 is a diagram illustrating an example of an overall configuration of a storage system according to an embodiment;

FIG. 2 is a diagram illustrating an example of a hardware configuration of the storage system according to the embodiment;

FIG. 3 is a diagram illustrating an example of an infection management table of the storage system according to the embodiment;

FIG. 4 is a diagram illustrating an example of an update history management table of the storage system according to the embodiment;

FIG. 5 is a diagram illustrating an example of a generation management table of the storage system according to the embodiment;

FIG. 6 is a diagram illustrating an example of a tier capacity management table of the storage system according to the embodiment;

FIG. 7 is a diagram illustrating an example of an SS internal information management table of the storage system according to the embodiment;

FIG. 8 is a diagram illustrating an example of a tier management information table of the storage system according to the embodiment;

FIG. 9 is a diagram illustrating an example of a tier relocation processing table of the storage system according to the embodiment;

FIG. 10 is a diagram illustrating an example of an infected file specifying processing table of the storage system according to the embodiment;

FIG. 11 is a diagram illustrating an example of an operation of the storage system according to the embodiment;

FIG. 12 is a diagram illustrating an example of an operation of the storage system according to the embodiment;

FIG. 13 is a diagram illustrating an example of an operation of the storage system according to the embodiment;

FIG. 14 is a diagram illustrating an example of an operation of the storage system according to the embodiment;

FIG. 15 is a diagram illustrating an example of an operation of the storage system according to the embodiment;

FIG. 16 is a diagram illustrating an example of an operation of the storage system according to the embodiment;

FIG. 17 is a flowchart illustrating an example of an operation of an infection detection unit of the storage system according to the embodiment;

FIG. 18 is a flowchart illustrating an example of an operation of a file management unit of the storage system according to the embodiment;

FIG. 19 is a flowchart illustrating an example of an operation of a generation management unit of the storage system according to the embodiment;

FIG. 20 is a flowchart illustrating an example of an operation of a tier capacity management unit of the storage system according to the embodiment;

FIG. 21 is a flowchart illustrating an example of an operation of a tier control unit of the storage system according to the embodiment;

FIG. 22 is a flowchart illustrating an example of an operation of a tier relocation determining unit of the storage system according to the embodiment;

FIG. 23 is a flowchart illustrating an example of an operation of an uninfected data specifying unit of the storage system according to the embodiment; and

FIG. 24 is a flowchart illustrating an example of an operation of a downgraded data specifying unit of the storage system according to the embodiment.

### DETAILED DESCRIPTION OF THE EMBODIMENT

Embodiments will be described with reference to the drawings. The embodiments to be described below do not limit the claims of the present invention, and not all the elements described in the embodiments or combinations of the elements are requisites for solutions of the present invention.

In the following description, a “memory” is one or more memories and may typically be a main storage device. At least one memory in a memory unit may be a volatile memory or a non-volatile memory.

In the following description, a “processor” is one or more processors. At least one processor is typically a microprocessor such as a CPU (Central Processing Unit) or may be another type of processor such as a GPU (Graphics Processing Unit). At least one processor may be a single core or a multi-core.

At least one processor may be a processor in a broad sense, such as a hardware circuit (for example, an FPGA (Field-Programmable Gate Array) or an ASIC (Application Specific Integrated Circuit)) performing some or all of the steps of processing.

In the present disclosure, a storage apparatus (device) includes a RAID apparatus or a plurality of RAID apparatuses including one storage drive or a plurality of storage drives such as one HDD (Hard Disk Drive) or SSD (Solid State Drive). When a drive is an HDD, for example, a SAS (Serial Attached SCSI) HDD may be included or a NL-SAS (Near Line SAS) HDD may be included.

In the following description, information which can be output in response to an input will be described with an expression of the form “xxx table,” but the information may be data with any data structure or may be a learned model such as a neural network that produces an output in response to an input. Accordingly, an “xxx table” can be referred to as “xxx information.”

In the following description, the configuration of each table is exemplary. One table may be divided into two or more tables. Some or all of two or more tables may be one table.

In the following description, a “program” processed as a subject will be described in some cases. However, the program is executed by a processor so that given processing is performed using storage resources (for example, a memory) and/or a communication interface device (for example, a port) appropriately. Therefore, a subject of the processing may be a program. Processing described using the program as a subject may be processing performed by a processor or a computer that includes the processor.

In the following description, when a “OO unit” is described as an operation entity, this means that a processor of an information processing apparatus included in a storage system realizes a function of the OO unit in which processing content of the OO unit which is a program stored in a memory is read and loaded (details will be described later).

The program may be installed on an apparatus such as a computer or may be in, for example, a recording medium (for example, a non-transitory recording medium) which can be read by a program distribution server or a computer. In the following description, two or more programs may be one program or one program may be realized as two or more programs.

In the drawings used to describe the embodiments, similar reference numerals are given to portions with similar functions and repeated description will be omitted.

In the following description, when identical types of elements are not distinguished from each other in description, reference numerals (or common reference numerals among reference numerals) are used. When identical types of elements are distinguished from each other in description, identification numbers (or reference numerals) of the elements are used in some cases.

The positions, sizes, shapes, ranges, and the like of constituent elements illustrated in the drawings may be different from actual positions, sizes, shapes, ranges, and the like to facilitate understanding of the present invention in some cases. Therefore, the present invention is not necessarily limited to the positions, sizes, shapes, ranges, and the like disclosed in the drawings.

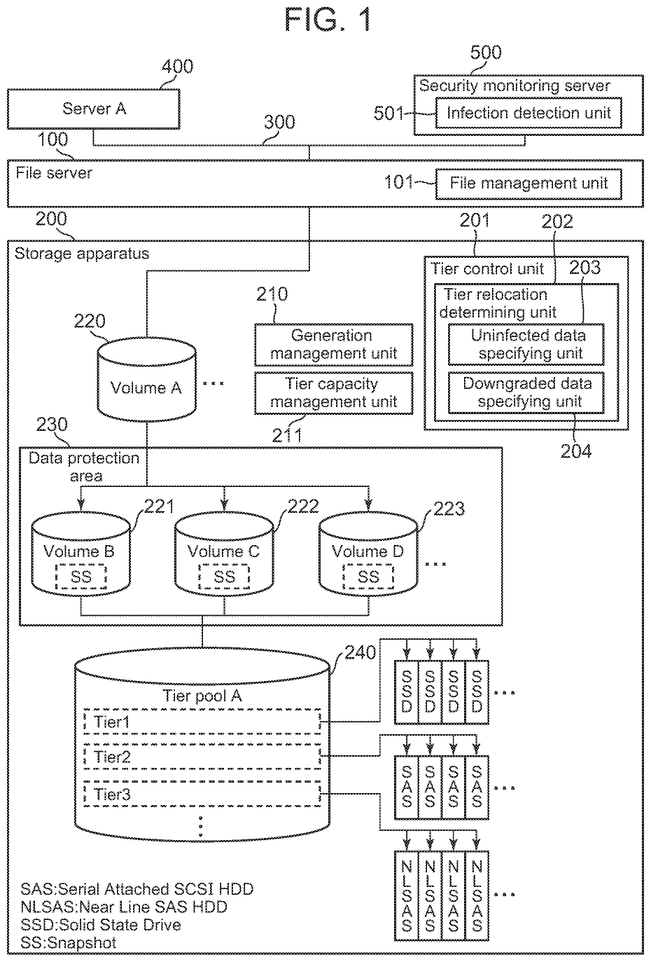

FIG. 1 is a diagram illustrating an example of an overall configuration of a storage system according to an embodiment.

A storage system 1 according to the embodiment includes a file server 100 and a storage apparatus 200. The file server 100 is configured to be able to communicate with a server A 400 and a security monitoring server 500 which are hosts via a network 300. The file server 100 and the storage apparatus 200 are configured to be able to transmit and receive information via a communication line.

The file server 100 and the storage apparatus 200 are configured by devices capable of performing various kinds of information processing, for example, information processing apparatuses such as computers. A hardware configuration of the file server 100 and the storage apparatus 200 will be described later.

The server A 400 performs instructions for various operations (reading, writing, erasing, updating, and the like) on files stored in the storage apparatus 200 via the file server 100 and the file server 100 performs an operation on files stored in the storage apparatus 200 based on an operation instruction from the server A 400. In FIG. 1, only the server A 400 is illustrated, but the number of servers 400 is not limited.

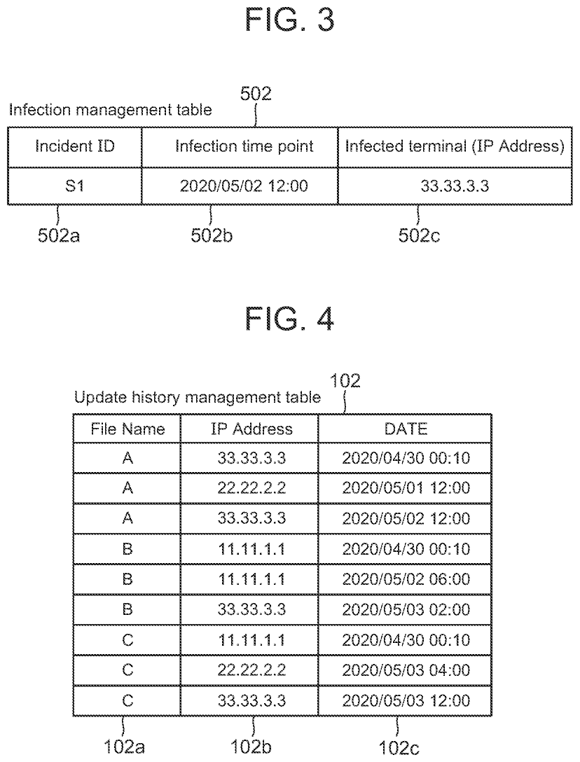

The security monitoring server 500 includes an infection detection unit 501. The infection detection unit 501 is configured to execute known security software or the like. When the server A 400 is normally (intermittently including normally), monitored and the server A 400 is infected with malware (a computer virus including malware), the infection detection unit 501 detects an event (incident) of the infection and acquires information for specifying an infection time point and an infected terminal (the server A 400). The security monitoring server 500 according to the embodiment acquires an IP address of the server A 400 as information for specifying an infected terminal. The information for specifying the infection time point and the infected terminal which is acquired by the security monitoring server 500 is stored in an infection management table 502 (see FIG. 3) not illustrated in FIG. 1.

The file server 100 includes a file management unit 101. The file management unit 101 is configured by executing file management software. The file management unit 101 acquires an update log of a file when a file stored in the storage apparatus 200 is operated and updated based on a file operation instruction from the server A 400. The update log includes the name of a file, an IP address serving as the information for specifying the server A 400 instructed to be operated, and a file update date. The file management unit 101 stores the file update log in an update history management table 102 (see FIG. 4) not illustrated in FIG. 1.

The storage apparatus 200 includes a tier control unit 201, a generation management unit 210, a tier capacity management unit 211, and storage apparatuses.

The tier control unit 201 manages the storage apparatuses of the storage apparatus 200 as a plurality of logical volumes. In the storage apparatus 200 according to the embodiment, the tier control unit 201 manages a volume A 220 in which files are operated based on an operation instruction from the server A 400 and volumes B to D 221 to 223 which are in a data protection area 230 where the files stored in the volume A 220 are periodically back up and stored. At this time, the tier control unit 201 stores the files stored in the volume A 220 as a snapshot (written as SS in FIG. 1 and referred to as an SS below) at a time point of backup processing. That is, the tier control unit 201 manages the files as an SS for each backup generation.

Of the storage apparatuses of the storage apparatus 200, storage apparatuses corresponding to the volumes B to D 221 to 223 are configured by a plurality of physical storage devices with different performances. In the storage apparatus 200 according to the embodiment illustrated in FIG. 1, an SSD, a SAS (Serial Attached SCSI HDD), and a NLSAS (Near Line SAS) are used for the configuration. The tier control unit 201 classifies the volumes B to D 221 to 223 into a plurality of storage tiers in accordance with the performance of the physical storage devices for management. In the storage apparatus 200 according to the embodiment, a tier pool A 240 in which the SSD is classified as a first tier (Tier1), the SAS is classified as second tier (Tier2), and the NLSAS is classified as a third tier (Tier3) is managed. The number of tiers and the physical storage devices which are allocated to the tiers are not limited to the illustrated example and can be determined arbitrarily.

The tier control unit 201 includes a tier relocation determining unit 202. The tier relocation determining unit 202 performs a tier relocation operation for the files in consideration of an infection time point of malware, information for specifying the terminal (the server A 400) infected with the malware, and a file update history using detection of malware infection of the server A 400 by the security monitoring server 500 as a trigger with regard to the files stored in the tier pool A 240. The details of the tier relocation operation for the files by the tier relocation determining unit 202 will be described below with reference to flowcharts.

In the tier relocation determining unit 202, a tier relocation processing table 205 and an infected file specifying processing table 206 are stored. The details of the tier relocation processing table 205 and the infected file specifying processing table 206 will be described below.

The tier relocation determining unit 202 includes an uninfected data specifying unit 203 and a downgraded data specifying unit 204. The details of operations of the uninfected data specifying unit 203 and the downgraded data specifying unit 204 will be described below with reference to flowcharts.

The generation management unit 210 acquires and manages information regarding generations or the like of the SS whenever the SS of the files stored in the volumes B to D 221 to 223 in the data protection area 230 is acquired. The generation management unit 210 includes a generation management table 213 and an SS internal information management table 214. The details of the generation management table 213 and the SS internal information management table 214 will be described below.

The tier capacity management unit 211 manages a vacant capacity in each tier of the tier pool A 240 and an address and a tier at which the files are stored. The tier capacity management unit 211 updates management information using occurrence of addition, change, or deletion of a file in each tier as a trigger. The tier capacity management unit 211 includes a tier capacity management table 215 and a tier management information table 216. The details of the tier capacity management table 215 and the tier management information table 216 will be described below.

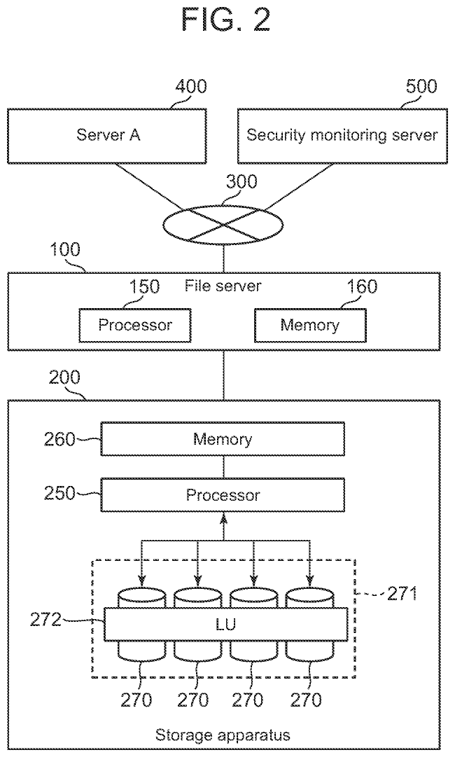

FIG. 2 is a diagram illustrating an example of a hardware configuration of the storage system 1 according to the embodiment.

The file server 100 and the storage apparatus 200 are configured by apparatuses capable of performing various kinds of information processing. The file server 100 and the storage apparatus 200 each include processors 150 and 250, memories 160 and 260, and communication interfaces (not shown), and include input devices such as mouses and keyboards and display apparatuses such as displays, as necessary.

The processors 150 and 250 are, for example, CPUs (Central Processing Units), GPUs (Graphic Processing Units), FPGAs (Field-Programmable Gate Arrays), or the like. The memories 160 and 260 are, for example, magnetic storage media such as HDDs (Hard Disk Drives) or semiconductor storage media such as RAMs (Random Access Memories), ROMs (Read Only Memories), or SSDs (Solid State Drives). A combination of an optical disc such as a DVD (Digital Versatile Disk) and an optical disc drive is used as a storage medium. In addition, a known storage medium such as a magnetic tape medium is also used as a storage medium.

In the memories 160 and 260, a program such as firmware is stored. When an operation of the file server 100 and the storage apparatus 200 starts (for example, power is fed), the program such as firmware is read from the memories 160 and 260 and is executed to control the entire storage system 1 including the file server 100 and the storage apparatus 200. In the memories 160 and 260, data or the like necessary for the file server 100 and the storage apparatus 200 to perform each processing is stored in addition to the program.

Further, the storage apparatus 200 includes a plurality of physical storage devices 270. The plurality of physical storage devices 270 include the SSD, the SAS, and the NLSAS described above. Of course, other physical storage devices, for example, various drives such as a hard disk device, a semiconductor memory device, an optical disc device, and a magneto-optical disc device with which reading and writing of data are possible may be included. Various storage apparatuses such as a flash memory, a FeRAM (Ferroelectric Random Access Memory), a MRAM (Magnetoresistive Random Access Memory), and a phase-change memory can also be used. Further, for example, different kinds of storage apparatuses may coexist.

Storage areas included in the plurality of physical storage devices 270 form a logical group 271. Logical volumes 272 (for example, volumes A to D 220 to 223) are configured in the storage areas of the logical group 271. FIG. 2 illustrates one logical volume 272, but the plurality of (many) logical volumes 272 are actually generated.

FIG. 3 is a diagram illustrating an example of the infection management table 502 of the storage system 1 according to the embodiment.

The infection management table 502 has, as entries, an ID 502a and a malware infection time point 502b for specifying an incident (malware infection) in the server A 400 or the like, and an IP address 502c for specifying a terminal (the server A 400) infected with malware.

FIG. 4 is a diagram illustrating an example of the update history management table 102 of the storage system 1 according to the embodiment.

The update history management table 102 has, as entries, a name 102a of a file instructed to be operated from the server A 400 which is a host, an IP address 102b for specifying the server A 400 instructed to be operated, and a date 102c at which a file is actually updated.

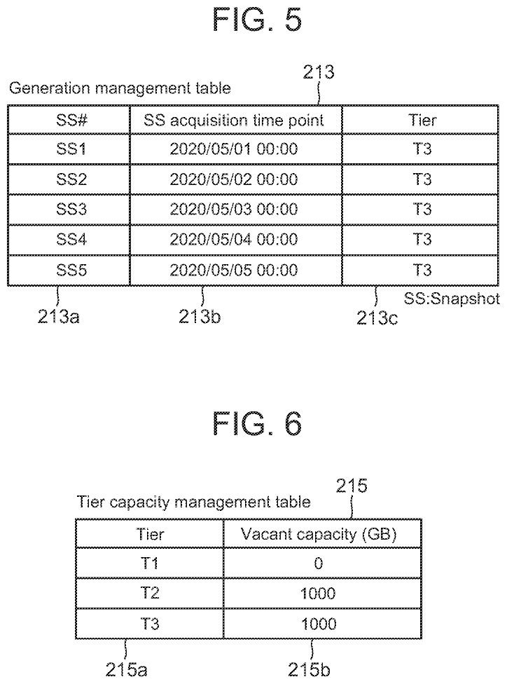

FIG. 5 is a diagram illustrating an example of a generation management table 213 of the storage system 1 according to the embodiment.

The generation management table 213 has, as entries, a number 213a for specifying a snapshot (SS) indicating a backup generation, an SS acquisition time point 213b, and information 213c indicating a tier in which the SS is stored.

FIG. 6 is a diagram illustrating an example of the tier capacity management table 215 of the storage system 1 according to the embodiment.

The tier capacity management table 215 has, as entries, a number 215a for specifying each tier and a vacant capacity 215b of the tier.

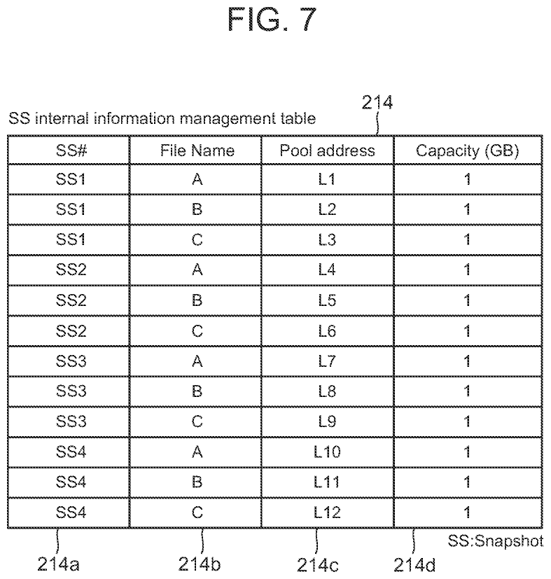

FIG. 7 is a diagram illustrating an example of an SS internal information management table 214 of the storage system 1 according to the embodiment.

The SS internal information management table 214 has, as entries, a number 214a for specifying a snapshot (SS), a name 214b of a file included in the SS, a number 214c of a pool in which a file is stored, and a capacity 214d of the file.

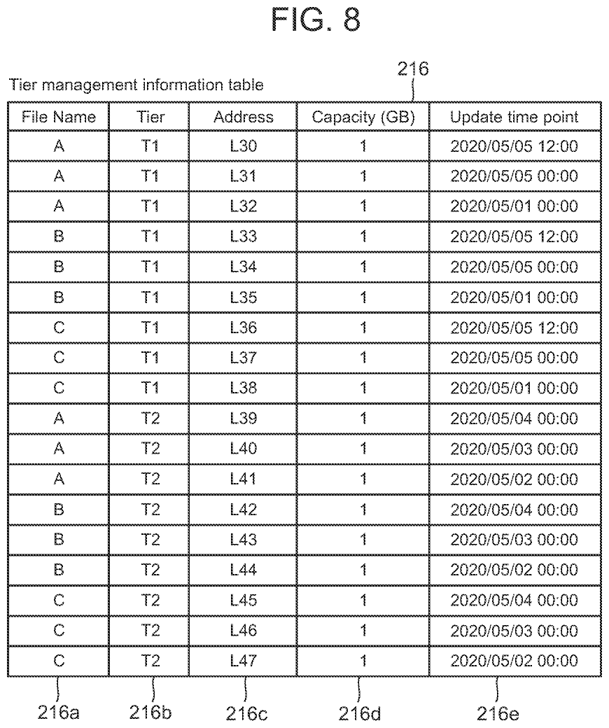

FIG. 8 is a diagram illustrating an example of the tier management information table 216 of the storage system 1 according to the embodiment.

The tier management information table 216 has, as entries, a name 216a of a file stored in the storage apparatus 200, a tier 216b in which the file is stored, an address 216c in which the file is stored, a capacity 216d of the file, and an update time point 216e of the file.

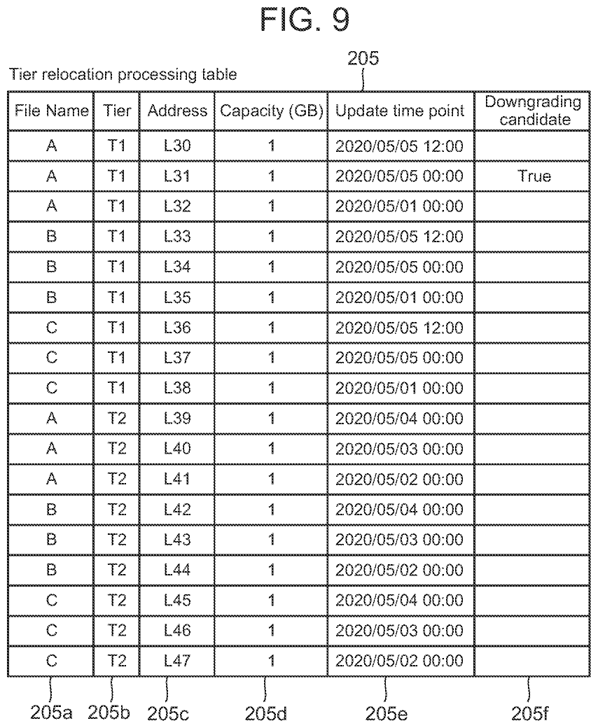

FIG. 9 is a diagram illustrating an example of the tier relocation processing table 205 of the storage system 1 according to the embodiment.

The tier relocation processing table 205 has, as entries, a name 205a of a file stored in the storage apparatus 200, a tier 205b in which the file is stored, an address 205c in which the file is stored, a capacity 205d of the file, an update time point 205e of the file, and a flag 205f indicating whether the file is a downgrading target.

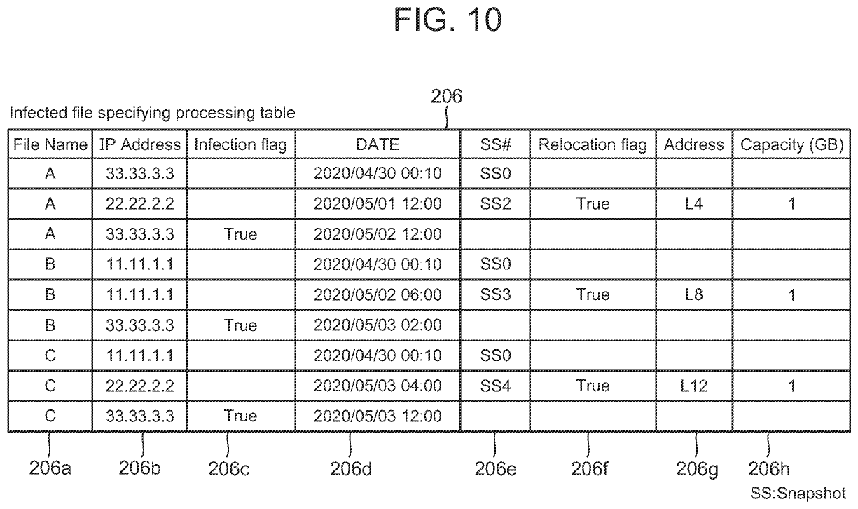

FIG. 10 is a diagram illustrating an example of an infected file specifying processing table 206 of the storage system 1 according to the embodiment.

The infected file specifying processing table 206 has, as entries, a name 206a of a file, an IP address 206b for specifying the server A 400 operating the file, a flag 206c indicating whether it is determined whether the file is infected with malware, a time point 206d at which the file is operated, an SS 206e in which the file is stored, a flag 206f indicating whether the file is relocated, an address 206g in which the file is stored, and a capacity 206h of the file.

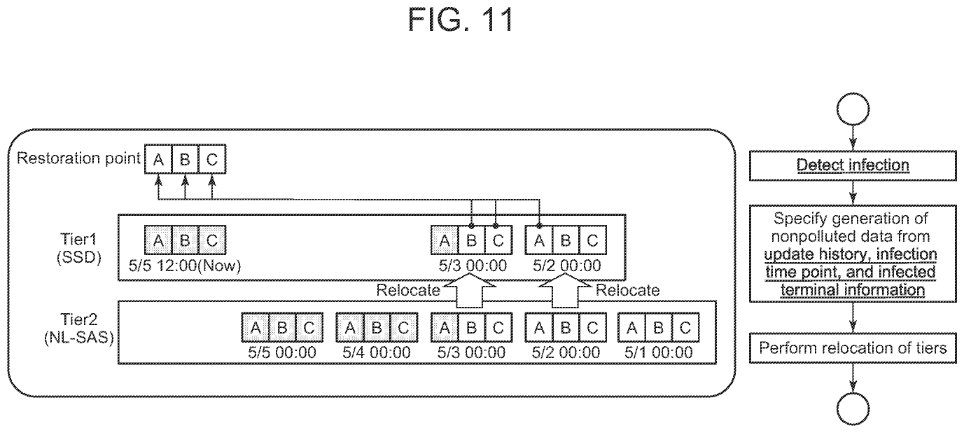

Next, an overview of an operation of the storage system 1 according to the embodiment will be described with reference to FIGS. 11 to 16.

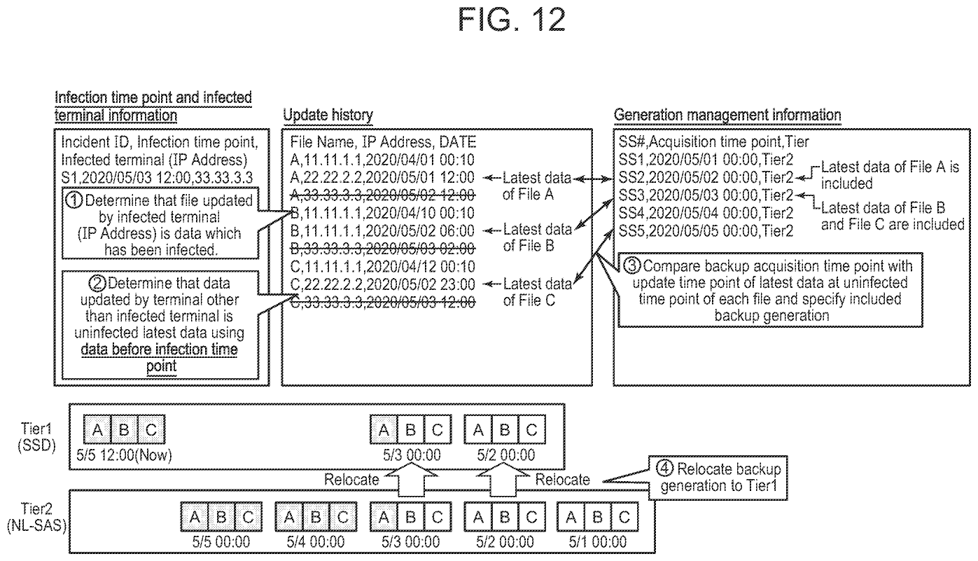

FIGS. 11 and 12 are diagrams illustrating one feature of an operation of the storage system 1 according to the embodiment. One feature of an operation of the storage system 1 according to the embodiment is “tier relocation” in consideration of an update history, an infection time point, and infected terminal information in which infection detection is used as a trigger.”

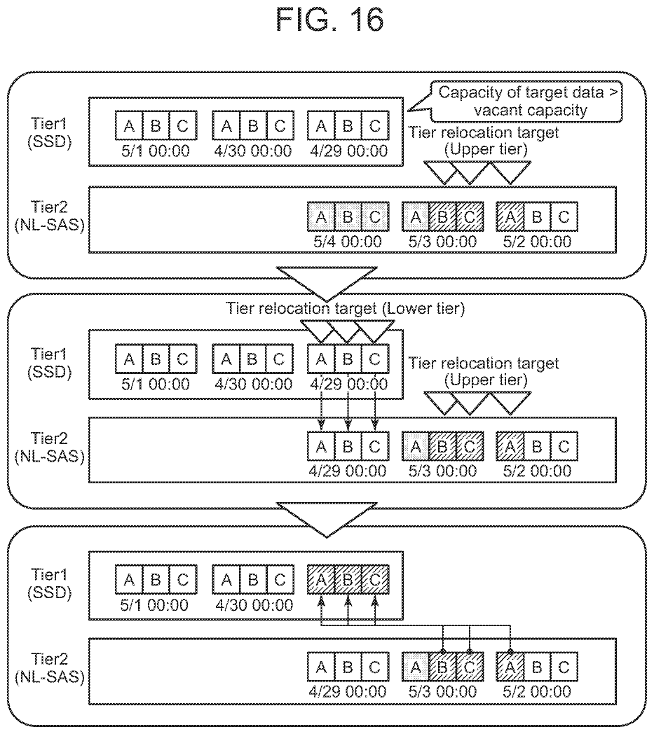

In FIG. 11, it is assumed that the infection detection unit 501 of the security monitoring server 500 detects malware infection of the certain server A 400 at 12:00 of 5/3. A present time point is assumed to be 12:00 of 5/5. The storage apparatus 200 specifies a generation of the SS in which the terminal is determined not to be infected (to be uninfected) with malware from an update history of a file, an infection time point of malware, and infected terminal information. In description of FIG. 11 (and to FIG. 16), the SS is formed by files A to C and an individual rectangle indicates a file. An outlined rectangle indicates a file determined not to be infected (to be uninfected) with malware. A gray rectangle indicates a file determined to be infected with malware from the update history, the infection time point, and the infected terminal information.

The storage apparatus 200 relocates the SS including the files determined not to be infected with malware in the SS stored in Tier2 to Tier1. A backup restoration point is configured with only the files uninfected with malware.

An operation of the storage apparatus 200 will be described in more detail with reference to FIG. 12.

Based on the infection time point and the infected terminal information detected by the infection detection unit 501, the storage apparatus 200 determines that a file updated by the infected terminal is data which has been infected (1). In FIG. 12, a cancellation line (a horizontal line) is drawn in a history determined to be data which has been infected in the update history management table.

Subsequently, the storage apparatus 200 determines that the data updated by a terminal other than the infected terminal is latest data uninfected with malware using a file updated before the infection time point (2). In FIG. 12, in the update history management table, the latest data is specified in the individual files A to C in the SS.

Subsequently, the storage apparatus 200 compares a backup acquisition time point with an update time point of the latest data at the uninfected time point of each file specified at (2) with reference to the generation management table, and specifies a backup generation (that is, the SS) in which the latest data at the uninfected time point of the file is included (3).

Then, the storage apparatus 200 relocates the data of the backup generation specified in (3) to Tier1 (4).

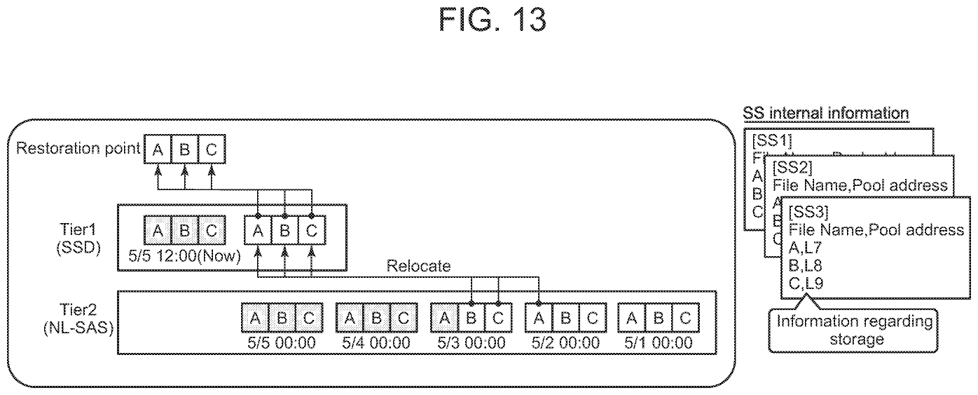

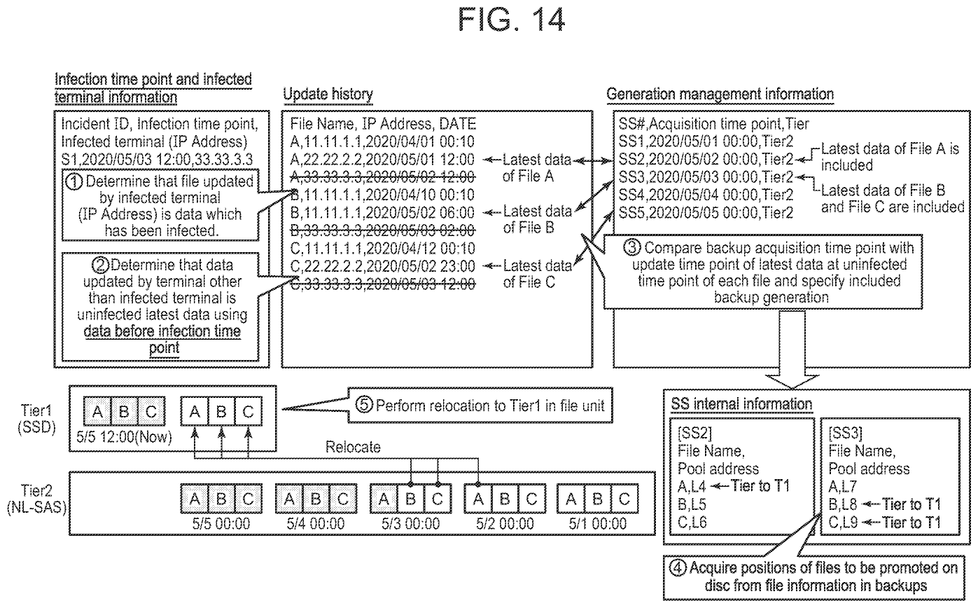

FIGS. 13 and 14 are diagrams illustrating other features of an operation of the storage system 1 according to the embodiment. Other features of the operation of the storage system 1 according to the embodiment are “not only management of the backup data in an acquisition generation unit but also management/combination in collection (the files or the like) of data in which consistency is necessary on an upper side.”

In FIG. 13, the storage apparatus 200 acquires information regarding an individual file in the storage apparatus 200 with reference to the SS internal information management table. Then, the storage apparatus 200 performs the relocation to Tier1 in a file unit other than the SS unit.

An operation of the storage apparatus 200 will be described in more detail with reference to FIGS. 14.

(1) to (3) are the same as the operation described in FIG. 12, and thus description thereof will be omitted. The storage apparatus 200 acquires positions of the files promoted (relocated) to Tier1 on the storage apparatus 200 with reference to the SS internal information management table (4). Then, the storage apparatus 200 performs the relocation to Tier1 in the file unit in which the positions are acquired in (4) (5).

In this way, the storage apparatus 200 appropriately relocates the files located in Tier2 to Tier1. However, when a vacant capacity of Tier1 is smaller than a capacity of the files to be relocated, it is difficult to relocate the files. Accordingly, the storage apparatus 200 downgrades files for which it is determined that no problem occurs to Tier2 despite the downgrading to Tier2 among the files located in Tier1.

As a scheme for downgrading the files to Tier2, two schemes are adopted in the storage apparatus 200 according to the embodiment. One is a scheme of downgrading data among data after an infection time point in order from the earliest update time point. The other is a scheme of downgrading data among data before the infection time point in order from the earliest update time point.

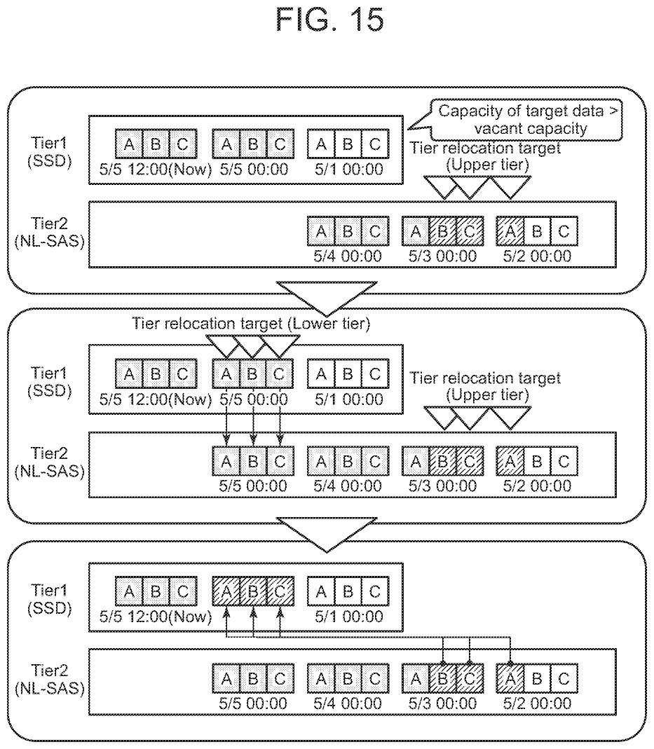

In FIG. 15 (and FIG. 16 to be described below), files which are candidates for relocation to Tier1 are indicated by hatched rectangles. In Tier1, it is assumed that the files equivalent to the SS corresponding to three generations have already been located, and thus a vacant capacity is insufficient. Accordingly, the storage apparatus 200 downgrades the files of which the update time point is old (in FIG. 15, 00:00 of 5/5) among the pieces of data after the infection time point, that is, the files determined to be infected, to Tier2, reserves a vacant capacity produced due to the downgrading, and then relocates the files to be promoted to Tier1.

Similarly, in FIG. 16, the storage apparatus 200 downgrades the files of which the update time point is old (in FIG. 15, 00:00 of 4/29) among the pieces of data before the infection time point, that is, the files determined to be uninfected, to Tier2, reserves a vacant capacity produced due to the downgrading, and then relocates the files to be promoted to Tier1.

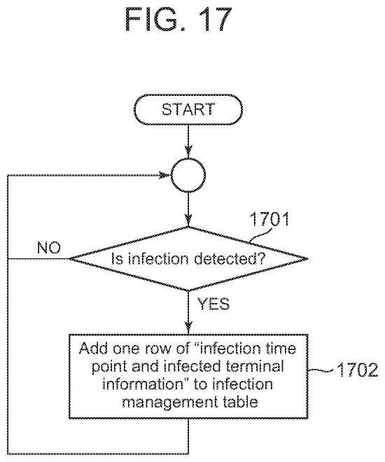

Next, operations of the storage system 1 according to the embodiment will be described with reference to the flowcharts of FIGS. 17 to 24.

FIG. 17 is a flowchart illustrating an example of an operation of the infection detection unit 501 of the storage system 1 according to the embodiment.

When the infection detection unit 501 detects that the host such as the server A 400 or the like is infected with malware (YES in 1701), one row of the infection time point 502b and the infected terminal information 502c is added to the infection management table 502 (1702).

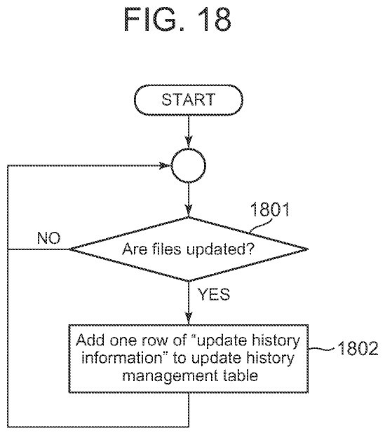

FIG. 18 is a flowchart illustrating an example of an operation of the file management unit 101 of the storage system 1 according to the embodiment.

When it is detected that the files are updated in the storage apparatus 200 (YES in 1801), the file management unit 101 adds one row of update history information formed by the name 102a of the file, the IP address 102b, and the date 102c to the update history management table 102 (1802).

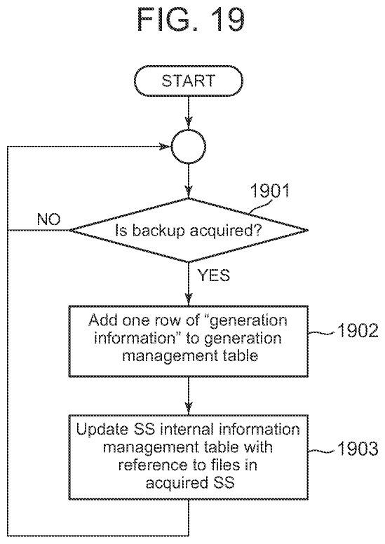

FIG. 19 is a flowchart illustrating an example of an operation of the generation management unit 210 of the storage system 1 according to the embodiment.

When the backup (SS) is acquired (YES in 1901), the generation management unit 210 adds one row of generation information formed by the acquisition time point 213b and the tier 213c to the generation management table 213 (1902). Subsequently, the generation management unit 210 updates the SS internal information management table 214 with reference to the files in the acquired SS (1903).

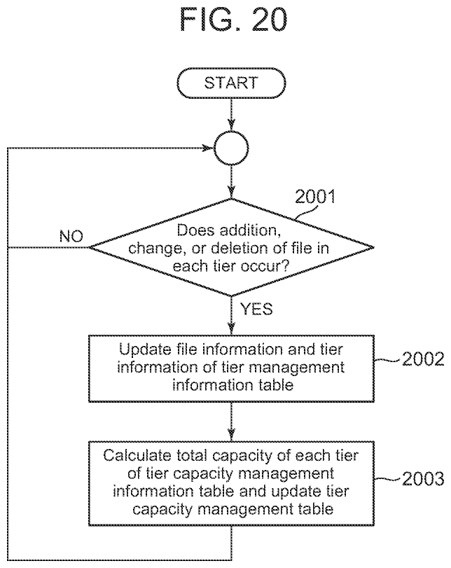

FIG. 20 is a flowchart illustrating an example of an operation of the tier capacity management unit 211 of the storage system 1 according to the embodiment.

When it is detected that addition, change, or deletion of a file in each tier occurs (YES in 2001), the tier capacity management unit 211 updates file information and tier information of the tier management information table 216 (2002). Subsequently, the tier capacity management unit 211 calculates a capacity of each tier of the tier capacity management table 215 and updates the tier capacity management table 215 (2003).

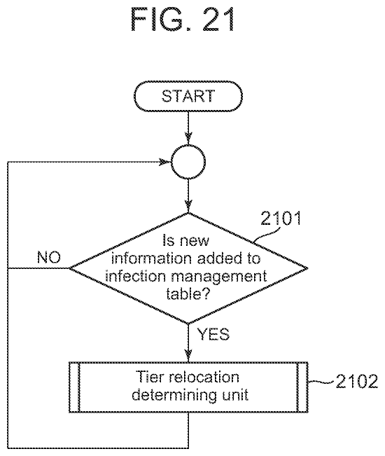

FIG. 21 is a flowchart illustrating an example of an operation of the tier control unit 201 of the storage system 1 according to the embodiment.

When addition of new information to the infection management table 502 is detected (YES in 2101), the tier control unit 201 starts an operation of the tier relocation determining unit 202 (2102).

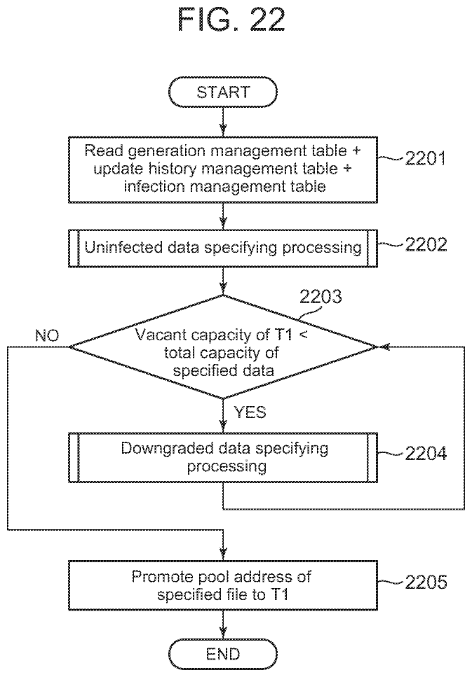

FIG. 22 is a flowchart illustrating an example of an operation of the tier relocation determining unit 202 of the storage system 1 according to the embodiment.

The tier relocation determining unit 202 first accepts the generation management table 213, the update history management table 102, and the infection management table 502 (2201). Subsequently, the tier relocation determining unit 202 starts of an operation of the uninfected data specifying unit 203 (2202).

Subsequently, the tier relocation determining unit 202 determines whether a total capacity of uninfected data specified by the uninfected data specifying unit 203 in 2202 is larger than a vacant capacity of Tier1 (2203). As a result, when it is determined that the total capacity of the uninfected data is larger than the vacant capacity of Tier1 (YES in 2203), the tier relocation determining unit 202 starts an operation of the downgraded data specifying unit 204 (2204). Conversely, when it is determined that the total capacity of the uninfected data is equal to or smaller than the vacant capacity of Tier1 (NO in 2203), the tier relocation determining unit 202 promotes the pool address of the specified file to Tier1 (2205).

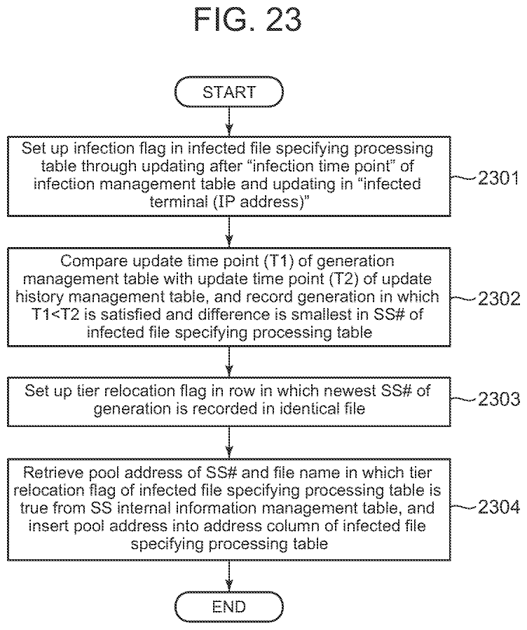

FIG. 23 is a flowchart illustrating an example of an operation of the uninfected data specifying unit 203 of the storage system 1 according to the embodiment.

The uninfected data specifying unit 203 sets up an infection flag 206c in the infected file specifying processing table 206 with regard to the files updated by the infected terminal through updating after the infection time point of the infection management table 502 (2301).

Subsequently, the uninfected data specifying unit 203 compares an update time point (referred to as T1) of the generation management table 213 with an update time point (referred to as T2) of the update history management table 102, and records a generation in which T1<T2 is satisfied and the difference between T1 and T2 is the smallest in SS 206e of the infected file specifying processing table 206 (2302).

Further, the uninfected data specifying unit 203 sets up a relocation flag 206f in a row in which the newest SS 206e of the generation is recorded in the identical file in the infected file specifying processing table 206 (2303).

Then, the uninfected data specifying unit 203 retrieves the pool address 214c and the name 214b of the file in which the relocation flag 206f of the infected file specifying processing table 206 is true from the SS internal information management table 214 and inserts the pool address into the address 206g of the infected file specifying processing table 206.

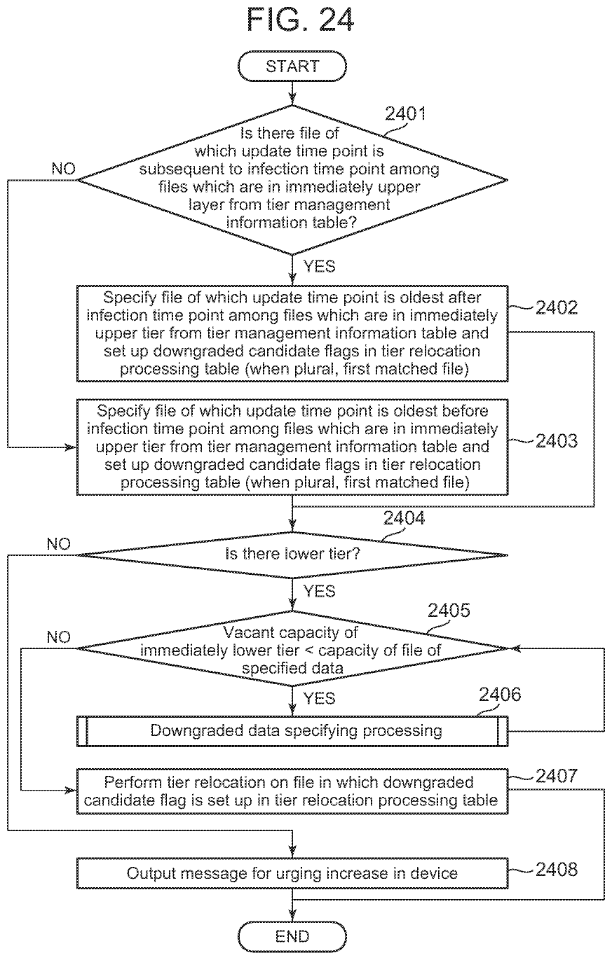

FIG. 24 is a flowchart illustrating an example of an operation of a downgraded data specifying unit 204 of the storage system 1 according to the embodiment.

First, the downgraded data specifying unit 204 retrieves the tier management information table 216 and determines whether there is a file of which the update time point is subsequent to the infection time point among the files which are in an immediately upper tier (2401). Then, when it is determined that there is the file of the update time point is subsequent to the infection time point (YES in 2401), the processing proceeds to 2402. When it is determined that there is no file of which the update time point is subsequent to the infection time point (NO in 2401), the processing proceeds to 2403.

In 2402, the downgraded data specifying unit 204 retrieves the tier management information table 216, specifies the file of which the update time point is the oldest after the infection time point among the files which are in the immediately upper tier, and sets up the downgraded candidate flag 205f of the tier relocation processing table 205 with regard to the file. At this time, the downgraded data specifying unit 204 sets up the flag 205f with regard to a file in which a condition is first matched when the number of specified files is plural.

In 2403, conversely, the downgraded data specifying unit 204 retrieves the tier management information table 216, specifies the file of which the update time point is the oldest before the infection time point among the files which are in the immediately upper tier, and sets up the downgraded candidate flag 205f of the tier relocation processing table 205 with regard to the file. At this time, the downgraded data specifying unit 204 sets up the flag 205f with regard to a file in which a condition is first matched when the number of specified files is plural.

Subsequently, the downgraded data specifying unit 204 determines whether there is a lower tier (2404). When it is determined that there is the lower tier (YES in 2404), the processing proceeds to 2405. When it is determined that there is no lower tier (NO in 2404), the processing proceeds to 2408.

In 2405, it is determined whether a vacant capacity of an immediately lower tier is smaller than the capacity of the file specified in the flowchart of FIG. 23. When it is determined that the vacant capacity of an immediately lower tier is smaller than the capacity of the file specified in the flowchart of FIG. 23 (YES in 2405), the downgraded data specifying processing illustrated in FIG. 24 is performed again (2406). When it is determined that the vacant capacity of an immediately lower tier is equal to or larger than the capacity of the file specified in the flowchart of FIG. 23 (NO in 2405), the downgraded data specifying unit 204 performs relocation (downgrading) of the tier on the file in which the downgraded candidate flag 205f is set up in the tier relocation processing table 205 (2407).

In 2408, conversely, a message urging an operator to add a new physical storage device is output.

In the configuration according to the embodiment, it is possible to realize a storage system and a file relocation method for the storage system capable of finding a balance between a cost and a restoration speed of a storage device storing backup data.

That is, according to the embodiment, by performing tier relocation to an upper tier of only data to be restored, it is possible to find a balance between a cost and a restoration speed of a drive storing multi-generational backup data. Further, according to the embodiment, by managing the data to be restored in units of files (a collection of data in which consistency is necessary on an upper side), it is possible to reduce a disc capacity necessary for the high tier.

In the foregoing embodiment, the configurations disclosed to easily describe the present invention have been described. The present invention is not necessarily limited to all the described configurations. Some of the configurations according to the embodiments can be added to, deleted from or substituted with other configurations.

Some or all of the foregoing configurations, functions, processing units, processing mechanisms, and the like may be designed with, for example, integrated circuits to be realized by hardware. The present invention can be realized by program codes of software realizing the functions according to the embodiment. In this case, a storage medium recording the program codes is provided to a computer and a processor included in the computer reads the program codes stored in the storage medium. In this case, the functions according to the embodiments are realized by the program codes read from the storage medium, and the program codes and the storage medium storing the program codes embody the present invention. As the storage medium for supplying the program codes, for example, a flexible disc, a CD-ROM, a DVD-ROM, a hard disk, an SSD (Solid State Drive), an optical disc, a magneto-optical disc, a CD-R, a magnetic tape, a nonvolatile memory card, a ROM, or the like is used.

The program codes realizing the functions described in the embodiment can be mounted in, for example, a widespread program or script language such as Assembly, C/C++, perl, Shell, PHP, Java (registered trademark), or Python.

In the above-described embodiment, control lines or information lines indicate conceivable lines necessary for description and are not necessarily all the control lines or information lines necessary for products. All the configurations may be connected to each other.

What is claimed is:

1. A storage system that is connected to a host and performs an operation on stored files based on a file operation request from the host, the storage system comprising:
a controller; and
a storage device,
wherein the controller manages the storage device as a first volume in which the files are stored and a second volume in which backup files of the files are stored,
wherein the second volume is configured by a plurality of physical storage devices with different performances and the controller classifies the second volume into a plurality of storage tiers for management in accordance with the performances of the physical storage devices, and
wherein the controller performs relocation of the storage tiers in which the backup files are stored in consideration of a logical fault occurrence time point of the host at which detection of a defect of an application and/or a system of the host is used as a trigger.

2. The storage system according to claim 1, wherein the controller performs the relocation of the storage tiers in which the backup files are stored in consideration of an infection time point of the host at which detection of malware infection of the host is used as a trigger.

3. The storage system according to claim 2,
wherein the storage system is connected to a plurality of the hosts, and
wherein the controller performs the relocation of the storage tiers in which the backup files are stored based on information for specifying the host infected with the malware and the infection time point of the host infected with the malware.

4. The storage system according to claim 3,
wherein the storage system includes a memory,
wherein the memory stores an update history management table that has information for specifying the files, information for specifying the host performing the file operation request on the files, and a time point at which processing of updating the files is performed, and
wherein, with reference to the update history management table, the controller specifies the files estimated not to be infected with the malware and performs the relocation of the storage tiers on the specified files.

5. The storage system according to claim 4, wherein the controller relocates the specified files in upper storage tiers than the storage tier in which the specified files are currently located.

6. The storage system according to claim 5, wherein the controller relocates the specified files in the uppermost storage tier.

7. The storage system according to claim 4,
wherein the controller backs the files stored in the first volume up to the second volume at a predetermined timing for each backup generation,
wherein the memory stores a generation management table that has information indicating the backup generation, a time point of the backup, and the storage tiers in which the backup files are stored, and
wherein, with reference to the generation management table, the controller specifies the files estimated not to be infected with the malware and perform relocation of the storage tiers on the specified files.

8. The storage system according to claim 7, wherein the controller performs the relocation of the storage tiers in units of backup generations.

9. The storage system according to claim 7,
wherein the memory stores a backup generation internal information management table that has information indicating the backup generations and information regarding the files included for each backup generation, and
wherein, with reference to the backup generation internal information management table, the controller specifies the files to be relocated.

10. The storage system according to claim 1, wherein, when the file located in a lower storage tier through the relocation is relocated to an upper storage tier than the lower storage tier and a vacant capacity of the upper storage tier is smaller than a capacity of the file to be relocated, the controller relocates the file located in the upper storage tier in a lower storage tier than the upper storage tier.

11. The storage system according to claim 10, wherein the controller relocates the file updated after the logical fault occurrence time point in a lower storage tier than the upper storage tier in order from the earliest update time point.

12. The storage system according to claim 10, wherein the controller relocates the file updated before the logical fault occurrence time point in a lower storage tier than the upper storage tier in order from the earliest update time point.

13. A file relocation method in a storage system that is connected to a host, performs an operation on stored files based on a file operation request from the host, and includes a controller and a storage device, the method comprising:
managing the storage device as a first volume in which the files are stored and a second volume in which backup files of the files are stored;
classifying the second volume into a plurality of storage tiers for management in accordance with the performances of the physical storage devices with the different performances;
performing relocation of the storage tiers in which the backup files are stored in consideration of a logical fault occurrence time point of the host at which detection of a defect of an application and/or a system of the host is used as a trigger.
